(19) United States
(12) Patent Application Publication
(10) Pub. No.: US 2025/0033278 A1
(43) Pub. Date: Jan. 30, 2025

(54) 3-D LATTICE REINFORCED COMPOSITE WITH STRAIN LIMITER

(71) Applicant: RTX Corporation, Farmington, CT (US)

(72) Inventor: Eli Warren, Wethersfield, CT (US)

(21) Appl. No.: 18/743,509

(22) Filed: Jun. 14, 2024

Related U.S. Application Data
(60) Provisional application No. 63/529,547, filed on Jul. 28, 2023.

(51) Int. Cl. B29C 64/171; B33Y 10/00; B33Y 70/00; B33Y 80/00

(52) U.S. Cl. CPC B29C 64/171; B33Y 10/00; B33Y 70/00; B33Y 80/00; B29K 2995/0016

(57) ABSTRACT

A three-dimensional (3-D) composite structure has a 3-D lattice structure that includes a plurality of struts, a matrix phase surrounding the 3-D lattice structure, and a strain limiting structure positioned at or near a center of the 3-D lattice structure. The strain limiting structure is fixed to at least one of the plurality of struts. The 3-D composite structure can be made using additive manufacturing techniques.

### CROSS-REFERENCE TO RELATED APPLICATION

This application claims priority from U.S. Patent Application 63/529,547 filed on Jul. 28, 2023, the subject matter of which is incorporated into this application by reference in its entirety.

### BACKGROUND

The present disclosure relates generally to composite structures and, more particularly, to three-dimensional (3-D) lattice reinforced composite structures.

Aircraft structures, such as engine and fuselage structures, face multiple challenges such as retaining sufficient stiffness to function effectively as structural components while addressing the three dimensional stresses that result from the aircraft maneuvering while in flight. Additionally, it is desirable for such structures to be light weight for fuel efficiency and payload capability.

In some applications, such structures can made from metallic or polymeric foam cores sandwiched between thin sheets of facing materials to form load bearing structures that may include aerodynamic surfaces. In some applications, the foam cores can be replaced by certain repeating 3-D lattice structures, which can be made from metallic or polymeric materials. Given the continued focus on identifying more effective materials for aerospace and other high performance applications, it is desirable to identify further materials that can demonstrate the desired combination of light weight, high stiffness, strength, and toughness.

### SUMMARY

One aspect of the invention includes a three-dimensional (3-D) composite structure having a 3-D lattice structure that includes a plurality of struts, a matrix phase surrounding the 3-D lattice structure, and a strain limiting structure positioned at or near a center of the 3-D lattice structure.

Another aspect of the invention includes a method of making a three-dimensional (3-D) composite structure, including the steps of forming, using additive manufacturing techniques, a 3-D lattice structure having a plurality of struts, forming, using additive manufacturing techniques, a matrix phase surrounding the 3-D lattice structure, and forming, using additive manufacturing techniques, a strain limiting structure positioned at or near a center of the 3-D lattice structure.

### BRIEF DESCRIPTION OF THE DRAWINGS

FIG. 1A is an isometric view of a stellated octahedron reinforcing lattice cell.

FIG. 1B is an isometric view of the stellated octahedron reinforcing lattice cell of FIG. 1A with a matrix phase.

FIG. 2A is an isometric view of another stellated octahedron reinforcing lattice cell.

FIG. 2B is an isometric view of another stellated octahedron reinforcing lattice cell of FIG. 2A with a matrix phase.

FIG. 3A is an isometric view of the stellated octahedron reinforcing lattice cell of FIG. 2A having a stain limiting structure.

FIG. 3B is an isometric view of the stellated octahedron reinforcing lattice cell of FIG. 3A with a matrix phase.

FIG. 4A is an isometric view of a pair of stellated octahedron reinforcing lattice cells having stain limiting structures.

FIG. 4B is an isometric view of a pair of stellated octahedron reinforcing lattice cells of FIG. 4A with a matrix phase.

FIG. 5A is an isometric view of another pair of stellated octahedron reinforcing lattice cells having stain limiting structures.

FIG. 5B is an isometric view of another pair of stellated octahedron reinforcing lattice cells of FIG. 5A with a matrix phase.

FIG. 6 is a isometric view of an exemplary a plurality of reinforcing lattice cells formed into a structure having face sheet.

### DETAILED DESCRIPTION

Certain aerospace and other high performance applications require structures that can demonstrate a combination of light weight, high stiffness, strength, and toughness. In some applications, such structures can made from metallic or polymeric foam cores sandwiched between thin sheets of facing materials to form load bearing structures that may include aerodynamic surfaces. In other applications, the foam cores can be replaced by certain repeating three-dimensional (3-D) lattices structures, can be made from metallic or polymeric materials.

Another option for such structures is to use a core of repeating 3-D lattice structures filled with a polymeric material, polymeric foam or metallic foam by themselves or surrounded by thin sheets of facing material to form reinforced sandwich materials. Such materials be used as load bearing structures and, if desired, may include aerodynamic surfaces. Surrounding or filling the repeating 3-D lattice structures, which can be made from metallic or polymeric materials, with a lower modulus, higher toughness, polymeric material, polymer foam, or metallic foam creates a composite material with the polymeric material or foam as a matrix phase and the 3-D lattice structures as a reinforcing phase. Such a composite can be designed to have high strength and stiffness and to have a very high global Poisson's ratio ≥1. When loaded in compression, contraction of the lattice elements around the tough matrix phase dissipates compressive forces and results in deformation with small strains. Such a composite will have high stiffness, high strength, and enhanced toughness.

The performance of composite materials made from a repeating 3-D lattice structure having a polymeric material, polymeric foam, or metallic foam matrix phase can be enhanced by embedding a strain limiting structure into the matrix phase at or near the center of each 3-D lattice structure. The strain limiting structure, which can have a higher strength than the matrix phase, limits deformation of struts that make up the 3-D lattice structure, resulting in an overall higher ultimate strength for the composite material.

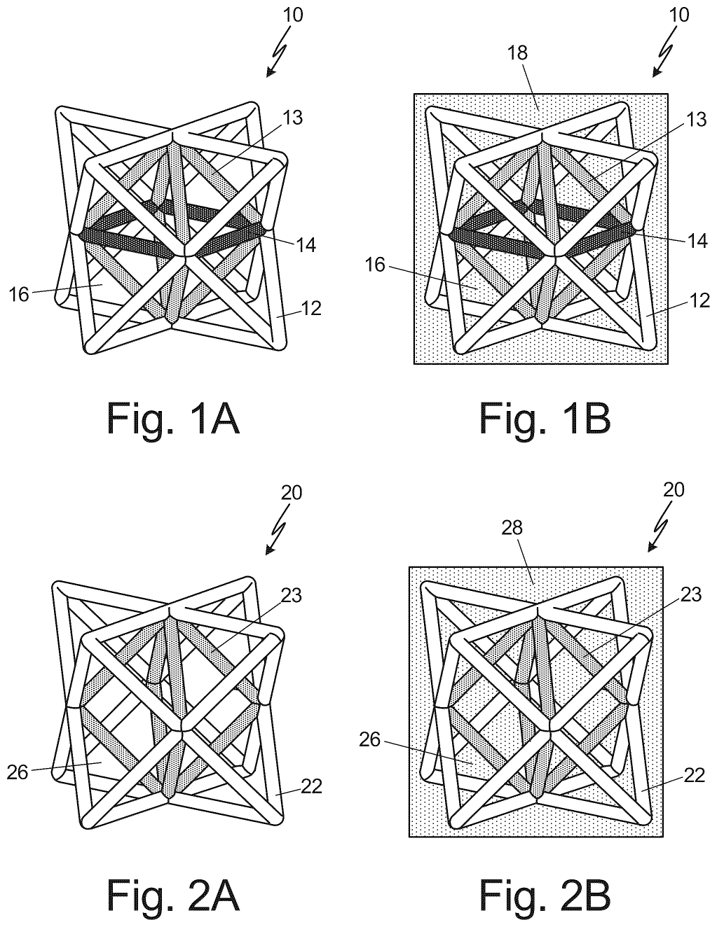

FIGS. 1A and 1B show 3-D lattice structures that can be the basis for the repeating 3-D lattice structure used as the reinforcing phase in the composite materials of this disclosure. The repeating 3-D lattice structure can be formed from any polymeric or metallic material deemed appropriate for a particular application. For example, the repeating 3-D lattice structure can be made from steel, aluminum, titanium and alloys, including but not limited to Inco 625. FIG. 1A shows a 3-D lattice structure 10, in this case a stellated octahedron, formed with a plurality of struts 12, including two sets of stiffening struts 13, 14. As discussed above, the struts 12, 13, 14 can be made from suitable metallic or polymeric materials and can be formed with additive manufacturing (AM) techniques known in the art. For example, the AM techniques can include powder bed fusion processes (e.g., laser powder bed fusion, electron beam powder bed fusion, etc.), direct ink writing, fused deposition modeling, material jetting, stercolithography, and other processes. Depending on the materials selected for the components of the 3-D lattice structure 10, it may be desirable to use an AM technique that can deposit multiple materials in a single build campaign.

While the struts 12, 13, 14 are shown with constant diameter circular cross-sections, the cross-sections could also have any other suitable geometric shape (e.g., triangular, rectangular, pentangular, etc.) and may have varying cross-sectional dimensions. In some applications, the combination of materials used to make the struts 12, 13, 14 and the shape and cross-sectional dimensions of the struts 12, 13, 14 can be selected to result in components having mechanical properties, including but not limited to modulus and toughness, deemed appropriate for a particular application. The spaces the struts 12, 13, 14 include open spaces 16 that can be filled with a suitable matrix phase 18 (see FIG. 1B), such as a polymeric material, a polymeric foam, or a metallic foam, to form a composite material. The polymeric material, a polymeric foam, or a metallic foam can be any such material useful as a matrix phase 18 for a particular application. As discussed above, in some examples the polymeric material, a polymeric foam, or a metallic foam matrix phase 18 may have a lower modulus and higher toughness than the material used to make the struts 12, 13, 14. While the 3-D lattice structure 10 is shown as a stellated octahedron other 3-D geometric shapes formed with a lattice structure can be used as the reinforcing phase in the composite materials of this disclosure.

FIGS. 2A and 2B show a 3-D lattice structure 20 similar to that depicted in FIG. 1A with the reinforcing struts 14 removed. The resulting 3-D lattice structure 20 includes a plurality of struts 22 with a single set of stiffening struts 23. Removing the reinforcing struts 24 from the 3-D lattice structure 10 of FIG. 1A to form 3-D lattice structure 20 is an example of how the 3-D lattice structures of this disclosure can be “tuned” to absorb more energy. Similar to the 3-D lattice structure 10 of FIG. 1A, the 3-D lattice structure 20 of FIG. 2A include open spaces 26 that can be filled with a suitable matrix phase 28 (see FIG. 2B), such as a polymeric material, a polymeric foam, or a metallic foam, to form a composite material. The struts 22, 23 and the matrix 28 of FIGS. 2A and 2B can be made from the same materials and have the same properties as discussed above with regard to the comparable elements of FIGS. 1A and 1B and 2A/2B. While the 3-D lattice structure 20 is shown as a stellated octahedron other 3-D geometric shapes formed with a lattice structure can be used as the reinforcing phase in the composite materials of this disclosure.

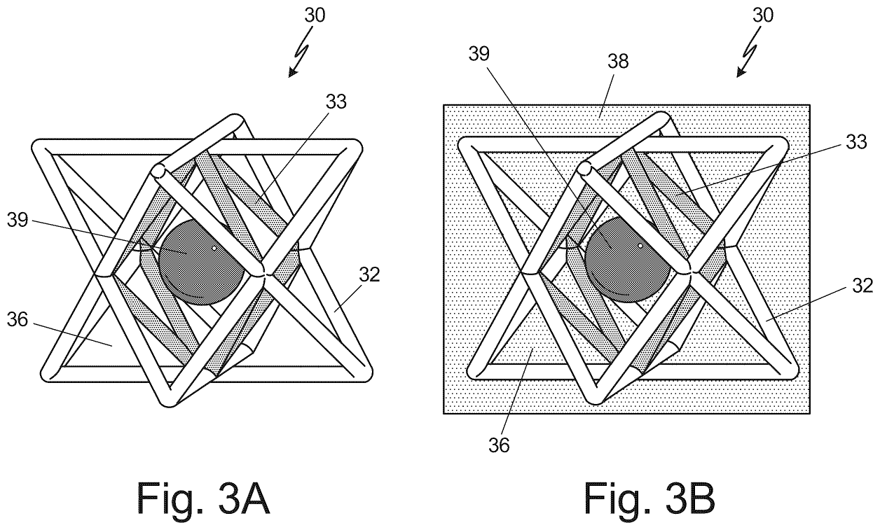

FIGS. 3A and 3B show a 3-D lattice structure 30 similar to that depicted in FIG. 2A that includes a strain limiting structure 39 positioned an open space 36 at or near the center of the 3-D lattice structure 30 such that strain limiting structure 39 will be embedded in the matrix phase 38 (see FIG. 3B) when the 3-D lattice structure 30 in filled with the matrix phase 38. The struts 32, 33 and the matrix 38 of FIGS. 3A and 3B can be made from the same materials and have the same properties as discussed above with regard to the comparable elements of FIGS. 1A/1B and 2A/2B. The strain limiting structure 39 of FIGS. 3A and 3B can have a higher strength (and in some examples, higher hardness) than the matrix 38 of FIG. 3B to limit further the deformation of the struts 32, 33 of the 3-D lattice structure 30. In some examples, the strain limiting structure 39 of the 3-D lattice structure 30 can be hollow or formed as a composite material, provided that the strain limiting structure 39 continues to have a higher strength (and in some examples, higher hardness) than the matrix 38 of FIG. 3B. As a result, a compressive or tensile load applied to the 3-D lattice structure 30 of FIG. 3B, will initially (and mostly) be absorbed/distributed by the Poisson effect created by deformation of the matrix phase 38. After some deformation of the lattice structure 30, the struts 32, 33 would contact the strain limiting structure 39 in the center of each 3-D lattice structure 30. The strain limiting structure 39 would provide much more resistance to deformation than the surrounding matrix phase 38. This construction will give the 3-D lattice structure 30 a much higher ultimate strength because the struts 32, 33 would be mostly intact and subjected to supported bending rather than buckling. In addition to including the strain limiting structure 39 in the center of each 3-D lattice structure 30, the struts 32, 33 can be designed to optimize the eventual interaction with it, i.e., the struts that would be subjected to compression could have an idealized shape for resistance to buckling while being bent around the solid object geometry. In some examples, the strain limiting structure 39 can be fixed to at least one of the plurality of struts 32, 33.

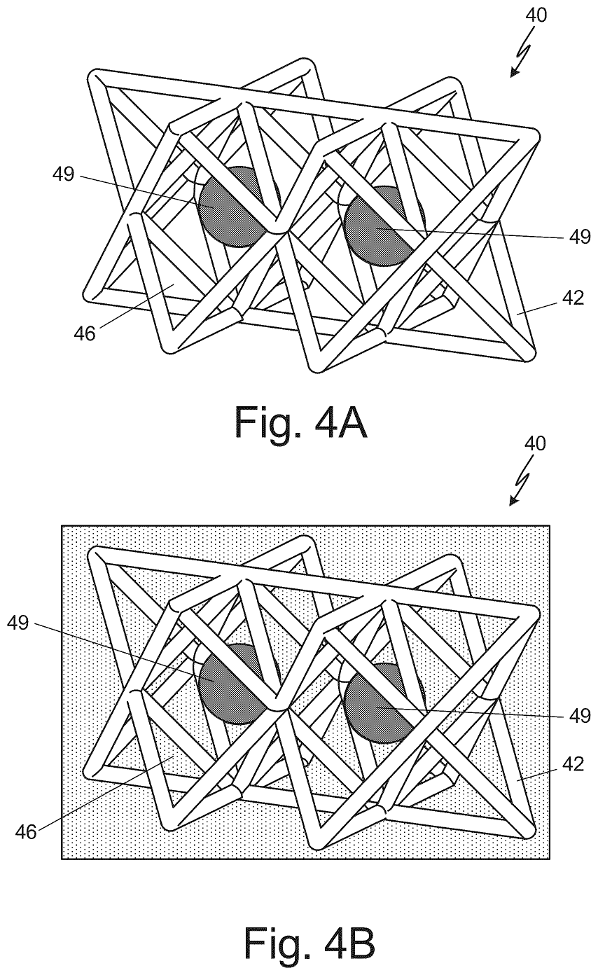

FIGS. 4A and 4B show a 3-D lattice structure 40 similar to that depicted in FIGS. 3A and 3B that include two lattice structures. It should understood that a 3-D lattice structure like that shown in FIGS. 4A and 4B can include any number of lattice structures as desirable for a particular application. Similar to the structures of FIGS. 3A and 3B, the 3-D lattice structure 40 includes a strain limiting structure 49 positioned an open space 46 at or near the center of the 3-D lattice structure 40 such that strain limiting structure 49 will be embedded in the matrix phase 48 (see FIG. 4B) when the 3-D lattice structure 40 in filled with the matrix phase 48. In some examples, the strain limiting structure 49 can be fixed to at least one of the plurality of struts 42.

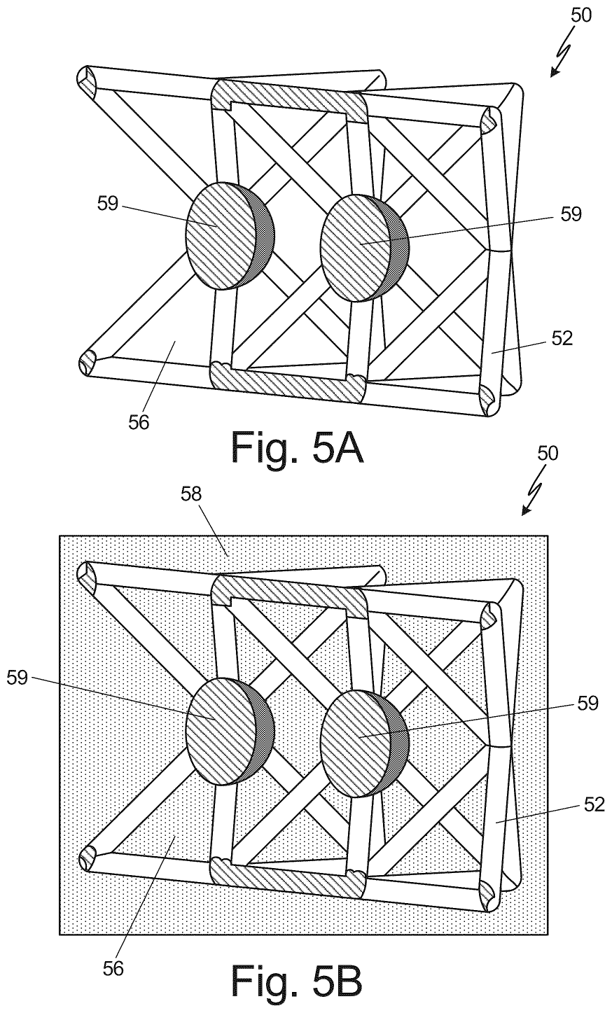

FIGS. 5A and 5B show a 3-D lattice structure 50 similar to that depicted in FIGS. 4A and 4B that include two lattice structures. As with the structures of FIGS. 4A and 4B, it should understood that a 3-D lattice structure like that shown in FIGS. 5A and 5B can include any number of lattice structures as desirable for a particular application. Similar to the structures of FIGS. 4A and 34, the 3-D lattice structure 50 includes a strain limiting structure 59 positioned an open space 56 at or near the center of the 3-D lattice structure 50 such that the strain limiting structure 59 will be embedded in the matrix phase 58 (see FIG. 5B) when the 3-D lattice structure 50 in filled with the matrix phase 58. The primary difference between the structures of FIGS. 5A and 5B and FIGS. 4A and 4B is the shape of the strain limiting structure 59 compared to the strain limiting structure 49. These differences illustrate that the shape of any of the strain limiting structures 39, 49, 59 described in this disclosure can be any shape suitable for a particular application and are not limited to the spheres depicted in FIGS. 3A/3B and 4A/4B and the hemisphere depicted in FIGS. 5A and 5B. In some examples, the strain limiting structure 59 can be fixed to at least one of the plurality of struts 52.

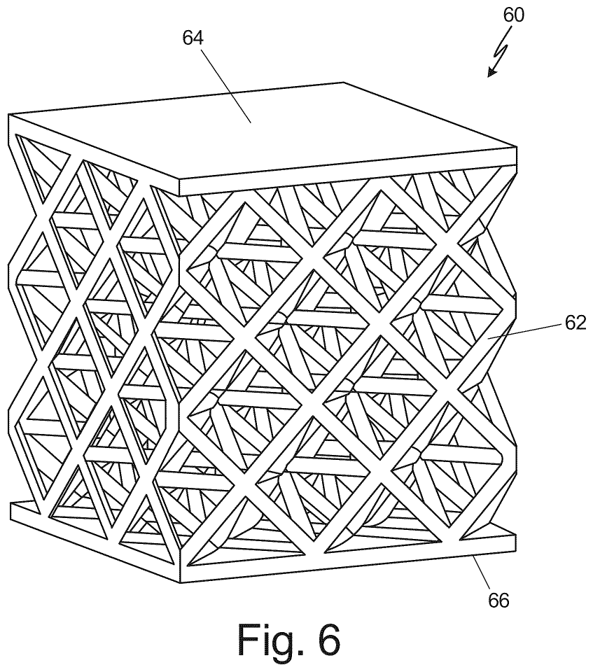

FIG. 6 is a isometric view of an exemplary reinforced structure 60 having a plurality of 3-D lattice structures 62 formed into a sandwich structure having a first face sheet 64 and a second face sheet 66. In this view, the 3-D lattice structures 62 are shown as generic 3-D lattice structures to illustrate the variety of 3-D lattice structures that can be used to form such a structure. For example, the 3-D lattice structures 62 can be any of the 3-D lattice structures depicted in FIGS. 1A-5A. The reinforced structure 60 can also include a matrix phase (not shown) as described with regard to FIGS. 1B-5B. When reinforced structure 60 is made with structures similar to those depicted in FIGS. 3B-5B, the full benefits described in this disclosure can be obtained.

For all of the examples discussed with regard to FIGS. 1A/1B, 2A/2B, 3A/3B, 4A/4B, 5A/5B, and 6, the desired strut 32, 42, 52 shapes can be made with suitable additive manufacturing (AM) techniques (i.e., 3-D printing). The strain limiting structures 39, 49, 59 can also be made with AM techniques and can designed to control the ultimate failure strength and mode of the 3-D lattice structures. As shown in FIGS. 3A/3B, 4A/4B, and 5A/5B, the struts 32, 42, 52 can be formed as rods and the strain limiting structures 39, 49, 59 of can be formed as a sphere or hemisphere. In some examples, though, the struts 32, 42, 52 can be formed without a uniform cross section along their respective lengths and can be axis asymmetric. Likewise, the strain limiting structures 39, 49, 59 can be any shape, including non-symmetric shapes, having any desired orientation. In addition, the strain limiting structures 39, 49, 59 can, in some examples, be a composites themselves to permit enhanced energy absorption. In another example, the matrix phase 38, 48, 58 and/or strain limiting structures 39, 49, 59 can be made of fire retardant materials so the 3-D lattice structures 30, 40, 50 can be used in fire resistant assemblies. Suitable fire retardant materials can include those deemed appropriate for a specific application, including but not limited to Tetrabromobisphenol A (TBBPA); Hexabromocyclododecane (HBCD); Ethane; 1,2-dibromo; Antimony oxide (Sb₂O₃); Triphenyl phosphate (TPP); Tricresyl phosphate (TCP). In still another example, the strain limiting structures 39, 49, 59 can be made in whole or in part from an electrorheological fluids to permit the properties of the strain limiting structures 39, 49, 59 to be altered by application of an electric current.

For all of the examples discussed with regard to FIGS. 1A/1B, 2A/2B, 3A/3B, 4A/4B, 5A/5B, and 6, the material properties for each component can be selected to provide desired performance in conjunction with all of the other properties of a 3-D composite structure. For example, the properties of interest for the structs 32, 42, 52 can include: yield flexural/bending strength, ultimate flexural/bending strength, yield compressive strength, ultimate compressive strength, stiffness (Young's modulus), hardness, ductility (% elongation to failure), and toughness. The properties of interest for the matrix phase 38, 48, 58 can include: resilience, viscosity (fluid), yield compressive strength, and ultimate compressive strength. The properties of interest for the strain limiting structures 39, 49, 59 can include: hardness, compressive strength, and stiffness. The properties of interest for the overall 3-D composite structure can include: Poisson's ratio, yield flexural/bending strength, ultimate flexural/bending strength, yield compressive strength, ultimate compressive strength, stiffness (Young's modulus), and fatigue limit.

The 3-D lattice structures of this disclosure are constructed to have a desirable combination of energy-absorption, toughness, ultimate strength, and stiffness. Using a multi-material AM machine (e.g., a multi-material 3D printer), the material used to form each component of the 3-D lattice structures can be selected to provide a selected level of performance. This can enable many custom uses or designs with very little added cost. The material use to form each component of the 3-D lattice structures can be printed and filled quickly, thus speeding up validation of any mechanical property analysis. The size, shape, and material of construction for each of the components (struts, matrix phase, and strain limiting structures) can be selected to meet requirements of particular applications. As discussed above, the strut cross-section can be non-circular and/or variable to achieve desired performance characteristics. Similarly, the strain limiting structures can be any shape and/or formed from a composite material. For example, the strain limiting structures can be gas filled to provide compressible cushion effect. The 3-D lattice structures can be formed from any suitable polyhedron shape. Combining metallic struts with a matrix phase made from a ductile metal with low melting point can allow for a metallic 3-D lattice structure useful for higher temperature applications.

### DISCUSSION OF POSSIBLE EMBODIMENTS

The following are non-exclusive descriptions of possible embodiments of the present invention.

A three-dimensional (3-D) composite structure, comprising a 3-D lattice structure that comprises a plurality of struts; a matrix phase surrounding the 3-D lattice structure; and a strain limiting structure positioned at or near a center of the 3-D lattice structure.

The 3-D composite structure of the preceding paragraph can optionally include, additionally and/or alternatively, any one or more of the following features, configurations and/or additional elements:

A further embodiment of the foregoing 3-D composite structure, wherein the 3-D lattice structure has a polyhedral shape.

A further embodiment of the foregoing 3-D composite structure, wherein the polyhedral shape is a stellated octahedron.

A further embodiment of any of the foregoing 3-D composite structures, wherein the plurality of struts comprise a polymeric material or a metallic material.

A further embodiment of any of the foregoing 3-D composite structures, wherein the matrix phase comprises a polymeric material, a polymeric foam, or a metallic foam.

A further embodiment of any of the foregoing 3-D composite structures, wherein the matrix phase comprises a material having a lower modulus and higher toughness than a material used to form the plurality of struts.

A further embodiment of any of the foregoing 3-D composite structures, wherein the strain limiting structure comprises a material having a higher strength that a material used to form the matrix phase.

A further embodiment of any of the foregoing 3-D composite structures, wherein the strain limiting structure comprises a hollow structure or a composite material.

A further embodiment of any of the foregoing 3-D composite structures, wherein the plurality of struts and the matrix phase are formed from fire-retardant materials.

A further embodiment of any of the foregoing 3-D composite structures, wherein the strain limiting structure comprises an electrorheological material.

A method of making a three-dimensional (3-D) composite structure, comprising the steps of: forming, using additive manufacturing techniques, a 3-D lattice structure that comprises a plurality of struts; forming, using additive manufacturing techniques, a matrix phase surrounding the 3-D lattice structure; and forming, using additive manufacturing techniques, a strain limiting structure positioned at or near a center of the 3-D lattice structure.

The 3-method of the preceding paragraph can optionally include, additionally and/or alternatively, any one or more of the following features, configurations and/or additional elements:

A further embodiment of the foregoing method, wherein the 3-D lattice structure has a polyhedral shape.

A further embodiment of the foregoing method, wherein the polyhedral shape is a stellated octahedron.

A further embodiment of any of the foregoing methods, wherein the plurality of struts comprise a polymeric material or a metallic material.

A further embodiment of any of the foregoing methods, wherein the matrix phase comprises a polymeric material, a polymeric foam, or a metallic foam.

A further embodiment of any of the foregoing methods, wherein the matrix phase comprises a material having a lower modulus and higher toughness than a material used to form the plurality of struts.

A further embodiment of any of the foregoing methods, wherein the strain limiting structure comprises a material having a higher strength that a material used to form the matrix phase.

A further embodiment of any of the foregoing methods, wherein the strain limiting structure comprises a hollow structure or a composite material.

A further embodiment of any of the foregoing methods, wherein the plurality of struts and the matrix phase are formed from fire-retardant materials.

A further embodiment of any of the foregoing methods, wherein the strain limiting structure comprises an electrorheological material.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A three-dimensional (3-D) composite structure, comprising:
a 3-D lattice structure that comprises a plurality of struts;
a matrix phase surrounding the 3-D lattice structure; and
a strain limiting structure positioned at or near a center of the 3-D lattice structure.

2. The 3-D composite structure of claim 1, wherein the 3-D lattice structure has a polyhedral shape.

3. The 3-D composite structure of claim 2, wherein the polyhedral shape is a stellated octahedron.

4. The 3-D composite structure of claim 1, wherein the plurality of struts comprise a polymeric material or a metallic material.

5. The 3-D composite structure of claim 1, wherein the matrix phase comprises a polymeric material, a polymeric foam, or a metallic foam.

6. The 3-D composite structure of claim 1, wherein the matrix phase comprises a material having a lower modulus and higher toughness than a material used to form the plurality of struts.

7. The 3-D composite structure of claim 1, wherein the strain limiting structure comprises a material having a higher strength that a material used to form the matrix phase.

8. The 3-D composite structure of claim 1, wherein the strain limiting structure is fixed to at least one of the plurality of struts.

9. The 3-D composite structure of claim 1, wherein the plurality of struts and the matrix phase are formed from fire-retardant materials.

10. The 3-D composite structure of claim 1, wherein the strain limiting structure comprises an electrorheological material.

11. A method of making a three-dimensional (3-D) composite structure, comprising the steps of:
forming, using additive manufacturing techniques, a 3-D lattice structure that comprises a plurality of struts;
forming, using additive manufacturing techniques, a matrix phase surrounding the 3-D lattice structure; and
forming, using additive manufacturing techniques, a strain limiting structure positioned at or near a center of the 3-D lattice structure and fixed to at least one of the plurality of struts.

12. The method of making 3-D composite structure of claim 11, wherein the 3-D lattice structure has a polyhedral shape.

13. The method of making 3-D composite structure of claim 12, wherein the polyhedral shape is a stellated octahedron.

14. The method of making 3-D composite structure of claim 11, wherein the plurality of struts comprise a polymeric material or a metallic material.

15. The method of making 3-D composite structure of claim 11, wherein the matrix phase comprises a polymeric material, a polymeric foam, or a metallic foam.

16. The method of making 3-D composite structure of claim 11, wherein the matrix phase comprises a material having a lower modulus and higher toughness than a material used to form the plurality of struts.

17. The method of making 3-D composite structure of claim 11, wherein the strain limiting structure comprises a material having a higher strength that a material used to form the matrix phase.

18. The method of making 3-D composite structure of claim 11, wherein the strain limiting structure wherein the strain limiting structure is fixed to at least one of the plurality of struts.

19. The method of making 3-D composite structure of claim 11, wherein the plurality of struts and the matrix phase are formed from fire-retardant materials.

20. The method of making 3-D composite structure of claim 11, wherein the strain limiting structure comprises an electrorheological material.
